(19) United States
(12) Patent Application Publication
(10) Pub. No.: US 2008/0068819 A1
(43) Pub. Date: Mar. 20, 2008

(54) LIGHT INTEGRATING SYSTEM

(76) Inventors: LIN MING-KUEN, Taoyuan (TW); Pao Chao-Han, Taoyuan (TW)

Correspondence Address: HOFFMAN WARNICK & D'ALESSANDRO, LLC, 75 STATE STREET, 14TH FLOOR, ALBANY, NY, 12207, US

(21) Appl. No.: 11/941,143

(22) Filed: Nov. 16, 2007

(30) Foreign Application Priority Data
May 18, 2006 (TW) 096117818
Nov. 17, 2006 (TW) 095142704

(51) Int. Cl. G03B 15/02; G02F 1/00

(52) U.S. Cl. 362/11; 362/235; 362/247; 359/237

(57) ABSTRACT

The invention provides a light integrating system, which includes a first light source, a second light source, and an integrating rod thereon defining an axial direction. The integrating rod includes a transmitting surface and a reflecting surface disposed beside the transmitting surface. There is an angle between the normal direction of the reflecting surface and the axial direction. The transmitting surface is substantially perpendicular to the axial direction. A first light emitted by the first light source passes through the transmitting surface into the integrating rod. A second light emitted by the second light source passes through a side surface of the integrating rod and is reflected by the reflecting surface into the integrating rod. The integrating rod mixes the first light and the second light reflected by the reflecting surface in the integrating rod and transmits them out.

### BACKGROUND OF THE INVENTION

1. Field of the Invention

The present invention relates to a light integrating system, and more particularly, to a light integrating system directly utilizing an integrating rod to mix two different light sources.

2. Description of the Prior Art

Optical devices (including light sources) are widely applied in various technologies. For example, these optical devices may be used in information transmission, displaying applications, pharmaceutical processes, and other applications of a wide range. The light sources used in these applications include a laser, a laser diode, an arc lamp, a light-emitting diode, and an incandescent lamp.

It is sometimes needed to increase the intensity of the light sources in order to present technologies with optical devices applied more efficiently. Because of the limitation in physics, an optical device with only one light source either lacks brightness for a specific application or fails to comply with many efficiency standards. For these cases, the total requested brightness can be satisfied by the lights from many light sources. However, it is difficult to uniformly mix the lights from many light sources to form a uniform light suitable for a special application.

Accordingly, the invention provides a light integrating system mixing at least two different light sources to solve the problem mentioned above.

### SUMMARY OF THE INVENTION

One scope of the invention provides a light integrating system directly utilizing an integrating rod to mix two different light sources.

According to a preferred embodiment, a light integrating system of the invention includes an integrating rod, a first light source, and a second light source. The integrating rod thereon defines an axial direction. The integrating rod includes a first end surface and a second end surface. The first end surface includes a transmitting surface and a first reflecting surface disposed beside a first side of the transmitting surface. The first reflecting surface can be coated with a layer of reflection material to enhance reflection. There is a first angle between the normal direction of the first reflecting surface and the axial direction. The transmitting surface is substantially perpendicular to the axial direction. A first light emitted by the first light source passes through the transmitting surface into the integrating rod. A second light emitted by the second light source passes through a side surface of the integrating rod and is then reflected by the first reflecting surface into the integrating rod. The integrating rod mixes the first light and the second light reflected by the first reflecting surface in the integrating rod and then transmits them through the second end surface. Therefore, the light integrating system can mix two light sources to improve the brightness.

In addition, the light integrating system further includes a third light source. The first end surface of the integrating rod includes a second reflecting surface beside a second side of the transmitting surface. The second reflecting surface can be also coated with a layer of reflection material to enhance reflection. There is a second angle between the normal direction of the second reflecting surface and the axial direction. A third light emitted by the third light source passes through another side surface of the integrating rod and is then reflected by the second reflecting surface into the integrating rod. The integrating rod mixes the first light, the second light reflected by the first reflecting surface, and the third light reflected by the second reflecting surface in the integrating rod and then transmits them through the second end surface. Therefore, the light integrating system can mix three light sources to more efficiently improve the brightness. Furthermore, when the first reflecting surface is adjacent to the second reflecting surface, the light integrating system of the invention mixes three light sources configured non-coplanarly.

In addition, the light integrating system further includes a light guide. The light guide is installed in such a way that the second light emitted by the second light source passes through the light guide and the first side surface and is then reflected by the first reflecting surface into the integration rod. Therefore, the light integrating system of the invention can still mix a plurality of light sources to improve the brightness even though the light sources are not adjacent to the integrating rod.

Therefore, the light integrating system of the invention can directly utilize an integrating rod to mix two or more different light sources to improve the brightness. In the applications of projectors, when LED light sources with various colors are used, a color wheel can further be skipped.

The advantage and spirit of the invention may be further understood by the following recitations together with the appended drawings.

### BRIEF DESCRIPTION OF THE APPENDED DRAWINGS

FIG. 1A is a sketch diagram illustrating a first preferred embodiment.

FIG. 1B is a sketch diagram illustrating the geometric relation between the first reflecting surface and the transmitting surface of the light integrating system.

FIG. 1C is a sketch diagram illustrating an embodiment.

FIG. 1D is a sketch diagram illustrating another geometric relation between the first reflecting surface and the transmitting surface of the light integrating system.

FIG. 2A is a sketch diagram illustrating a second preferred embodiment.

FIG. 2B is a sketch diagram illustrating the geometric relation between the first reflecting surface and the transmitting surface of the light integrating system.

FIG. 3 is a sketch diagram illustrating a third preferred embodiment.

FIG. 4 is a sketch diagram illustrating a fourth preferred embodiment.

FIG. 5A is a sketch diagram illustrating a fifth preferred embodiment.

FIG. 5B is a sketch diagram illustrating an embodiment of the invention.

FIG. 6 is a table of the brightness comparison of the invention to the conventional light integrating system with single light source.

### DETAILED DESCRIPTION OF THE INVENTION

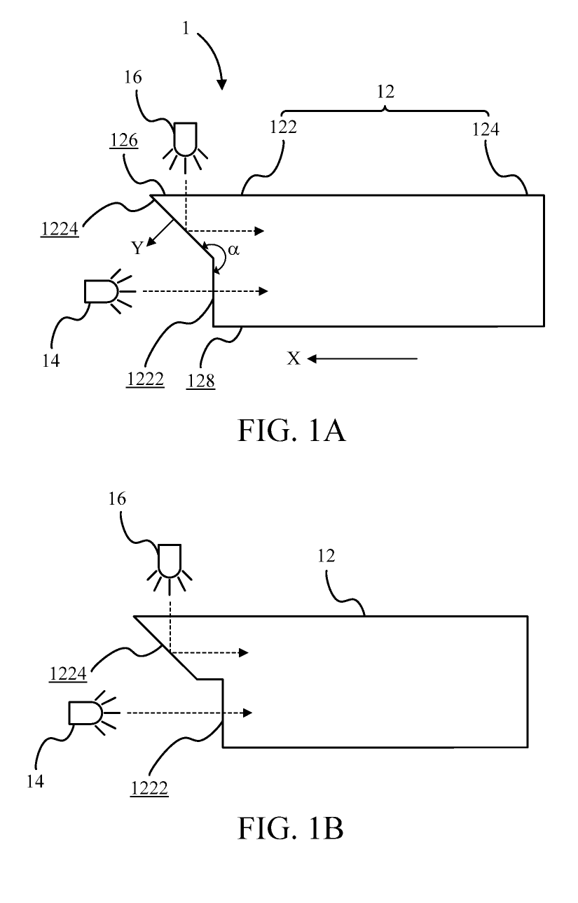

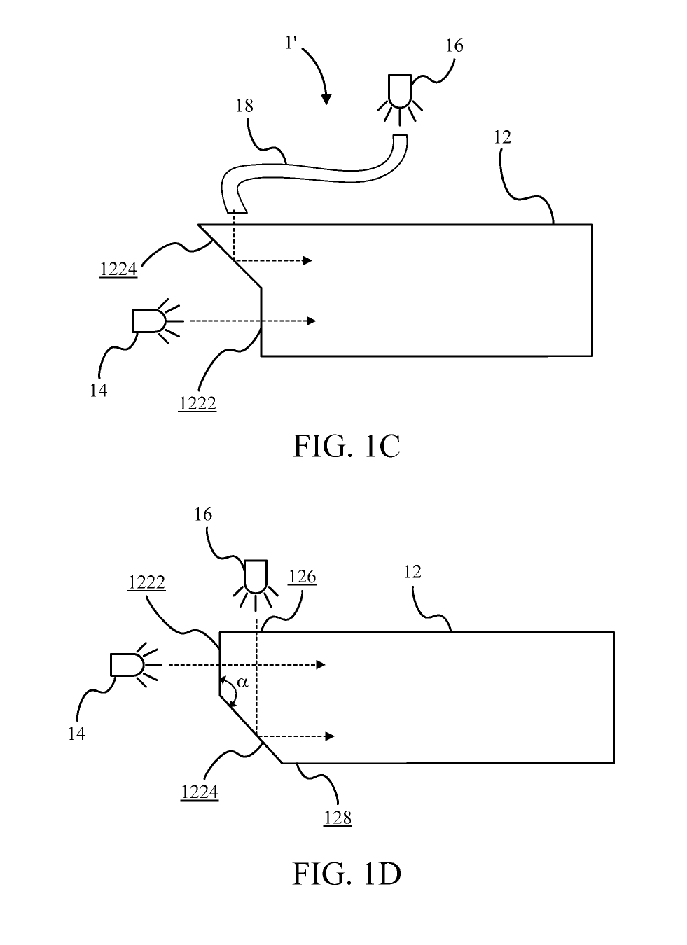

Please refer to FIG. 1A. FIG. 1A is a sketch diagram illustrating a first preferred embodiment. According to the first preferred embodiment, a light integrating system 1 of the invention includes an integrating rod 12, a first light source 14, and a second light source 16. The integrating rod 12 often includes a light-conductive material, and its cross section can be a rectangle, a square, or a hollow tube with a reflecting surface inside. The first light source 14 and the second light source 16 can be an arc lamp, an incandescent lamp, an LED, or other light sources.

The integrating rod 12 thereon defines an axial direction X. The integrating rod 12 includes a first end surface 122 and a second end surface 124. The first end surface 122 includes a transmitting surface 1222 and a first reflecting surface 1224. The first reflecting surface 1224 is disposed beside a first side of the transmitting surface 1222. As shown in FIG. 1A, the integrating rod 12 includes a first side surface 126 and a second side surface 128 opposite to the first surface 126. The two sides of the first reflecting surface 1224 are adjacent to the transmitting surface 1222 and the first side surface 126, respectively. There is an angle α between the first reflecting surface 1224 and the transmitting surface 1222. The angle α is from 180 degrees to 270 degrees. Therein, the first reflecting surface 1224 is adjacent to the transmitting surface 1222. However, it is not limited to this. In other words, the geometric relation between the first reflecting surface 1224 and the transmitting surface 1222 can also be what is shown in FIG. 1B.

The transmitting surface 1222 is substantially perpendicular to the axial direction X. The first reflecting surface 1224 can be coated with a layer of reflection material to enhance reflection, and it can even produce total reflection. The layer of reflection material can be gold, germanium, nickel, aluminum, palladium, platinum, indium, indium tin oxide, silicon dioxide, titanium dioxide, or a combination of the above. The layer of reflection material is presented not only in simple coating but also in a multi-layered structure or in a micro-structure. There is a first angle between the normal direction Y of the first reflecting surface 1224 and the axial direction X. That is, the first reflecting surface 1224 is not parallel to the axial direction X. FIG. 1A shows the first angle is about 45 degrees, but it is not limited to this.

Furthermore, a first light emitted by the first light source 14 passes through the transmitting surface 1222 into the integrating rod 12 (shown in a dashed arrow). The transmitting surface 1222 can be coated with a layer of anti-reflection material so that the first light can largely pass through the layer of anti-reflection material into the integrating rod 12. The layer of anti-reflection material is usually metal oxide, but it is not limited to this. The layer of anti-reflection material is presented not only in simple coating but also in a multi-layered structure or micro-structure.

Moreover, a second light emitted by the second light source 16 passes through the first side surface 126 of the integrating rod 12 and is then reflected by the first reflecting surface 1224 into the integrating rod 12 (shown in a dashed arrow). The integrating rod 12 mixes the first light and the second light reflected by the first reflecting surface 1224 in the integrating rod 12 and then transmits them through the second end surface 124. Therefore, the light integrating system 1 of the invention can mix the first light source 14 and the second light source 16 to improve the brightness.

In addition, please refer to FIG. 1C. FIG. 1C is a sketch diagram illustrating an embodiment. Compared with the first preferred embodiment, a light integrating system 1′ of the invention further includes a light guide 18 in this embodiment. In a preferred embodiment, the light guide 18 is a flexible light fiber. The light guide 18 is optically coupled to the integrating rod 12 by an end and the second light source 16 by another end, such that the second light emitted by the second light source 16 passes through the light guide 18 and the first side surface 126 of the integrating rod 12 and is then reflected by the first reflecting surface 1224 into the integrating rod 12. Therefore, the light integrating system 1′ overcomes the space configuration problem of light sources to mix more light sources to more efficiently improve the brightness.

It is worth noticing that, in the mentioned embodiments, the transmitting surface 1222 and the first reflecting surface 1224 are joined in a geometric concave, but the invention is not limited to this. Please refer to FIG. 1D. FIG. 1D is a sketch diagram illustrating another geometric relation between the first reflecting surface 1224 and the transmitting surface 1222 of the light integrating system 1. The transmitting surface 1222 and the first reflecting surface 1224 can be also joined in a geometric convex. That is, two sides of the first reflecting surface 1224 are adjacent to the transmitting surface 1222 and the second side surface 128, respectively. The angle α between the first reflecting surface 1224 and the transmitting surface 1222 is from 90 degrees to 180 degrees. In this case, the second light emitted by the second light source 16 crosses with the first light emitted by the first source 14 before reflected by the first reflecting surface 1224, as shown in the dashed line of FIG. 1D.

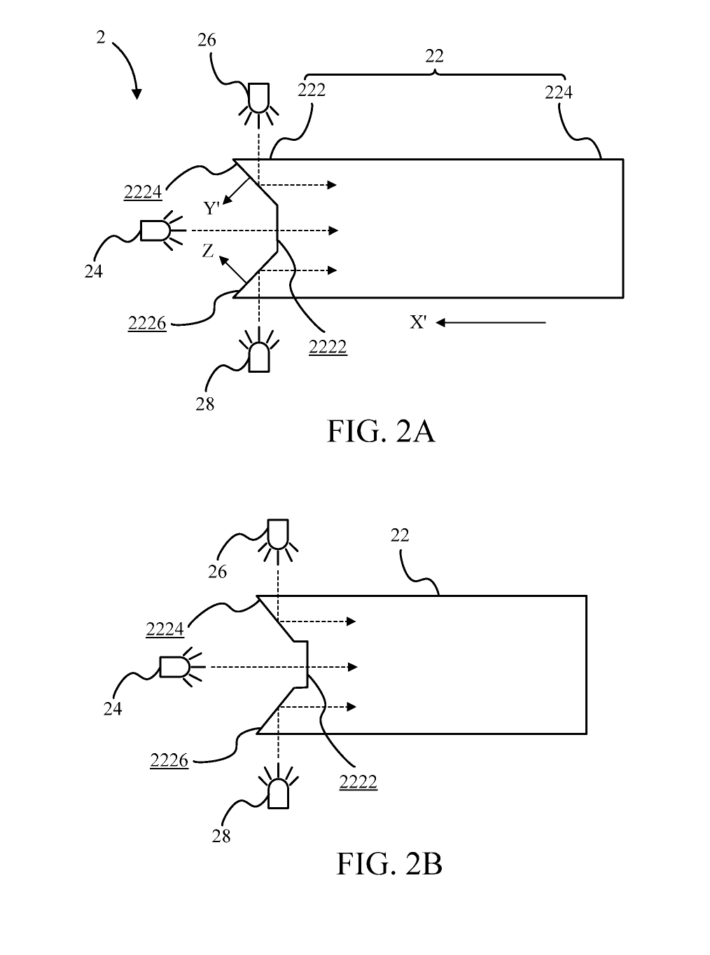

Please refer to FIG. 2A. FIG. 2A is a sketch diagram illustrating a second preferred embodiment. According to the second preferred embodiment, a light integrating system 2 of the invention includes an integrating rod 22, a first light source 24, a second light source 26, and a third light source 28. The integrating rod 22 thereon defines an axial direction X′. The integrating rod 22 includes a first end surface 222 and a second end surface 224. The first end surface 222 includes a transmitting surface 2222, a first reflecting surface 2224, and a second reflecting surface 2226. The first reflecting surface 2224 is disposed beside a first side of the transmitting surface 2222. The second reflecting surface 2226 is disposed beside a second side of the transmitting surface 2222. As shown in FIG. 2A, the first side is opposite to the second side. The first reflecting surface 2224 and the second reflecting surface 2226 are respectively adjacent to the transmitting surface 2222, but not limited to this. That is, the geometric relation among the first reflecting surface 2224, the second reflecting surface 2226, and the transmitting surface 2222 is shown in FIG. 2B. It could also be that either the first reflecting surface 2224 or the second reflecting surface 2226 is adjacent to the transmitting surface 2222.

The transmitting surface 2222 is substantially perpendicular to the axial direction X′. The transmitting surface can be coated with a layer of anti-reflection material such that a first light emitted by the first light source 24 can largely pass through the layer of anti-reflection material into the integrating rod 22. The first reflecting surface 2224 can be coated with a layer of reflection material to enhance reflection. The description for the layer of anti-reflection material and the layer of reflection material is the same as that in the first preferred embodiment, and it will not be described any further. There is a first angle between the normal direction Y′ of the first reflecting surface 2224 and the axial direction X′. There is also a second angle between the normal direction Z and the axial direction X′. In other words, neither the first reflecting surface 2224 nor the second reflecting surface 2226 is parallel to the axial direction X′. FIG. 2A shows that both the first angle and the second angle are about 45 degrees, but they are not limited to this. In addition, the additional description for the components of the light integrating system 2 is the same as that for the corresponding components of the light integrating system 1 in the first embodiment, and it will not be further described here.

Furthermore, the first light emitted by the first light source 24 passes through the transmitting surface 2222 into the integrating rod 22 (shown in a dashed arrow). A second light emitted by the second light source 26 passes through a side surface of the integrating rod 22 and is reflected by the first reflecting surface 2224 into the integrating rod 22 (shown in a dashed arrow). A third light emitted by the third light source 28 passes through another side surface of the integrating rod 22 and is reflected by the second reflecting surface 2226 into the integrating rod 22 (shown in a dashed arrow). The integrating rod 22 mixes the first light, the second light reflected by the first reflecting surface 2224, and the third light reflected by the second reflecting surface 2226 in the integrating rod 22 and then transmits them through the second end surface 224 of the integrating rod 22.

Therefore, the light integrating system 2 of the invention can mix the first light source 24, the second light source 26, and the third light source 28 to improve the brightness.

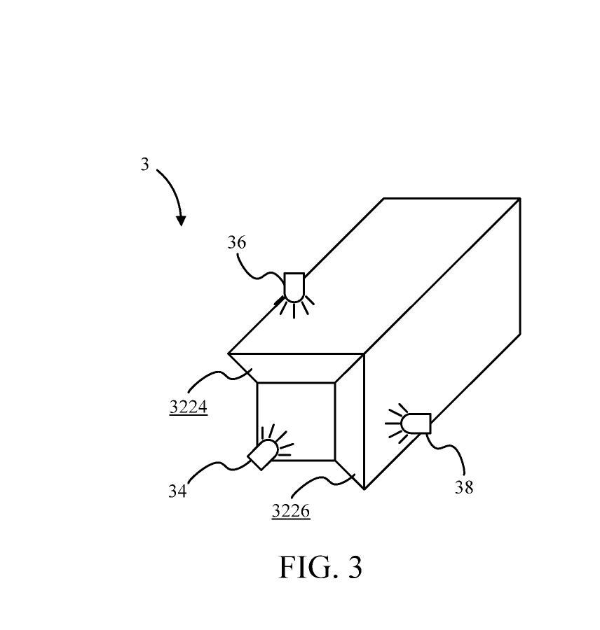

Please refer to FIG. 3. FIG. 3 is a sketch diagram illustrating a third preferred embodiment. Compared with the second embodiment, a first reflecting surface 3224 of a light integrating system 3 of the third preferred embodiment is adjacent to a second reflecting surface 3226 of the light integrating system 3. Consequently, a first light source 34, a second light source 36, and a third light source 38 of the light integrating system 3 can be configured non-coplanarly. In other words, the light integrating system 3 of the invention can mix three light sources configured non-coplanarly so that it can adapt to different light source configurations to improve the brightness.

It should be noticed that, in the above embodiments, the dashed lines representing the light paths indicate only the travel directions of the lights, not actual travel paths of the lights.

In the above embodiments, when the light integrating system of the invention is applied to a projection system with at least one LEDs as the light sources, the light integrating system can skip a color wheel because the LEDs can emit lights with different frequencies. Moreover, the integrating rod of the light integrating system of the invention can also mix lights with different frequencies to directly reach the effect of toning.

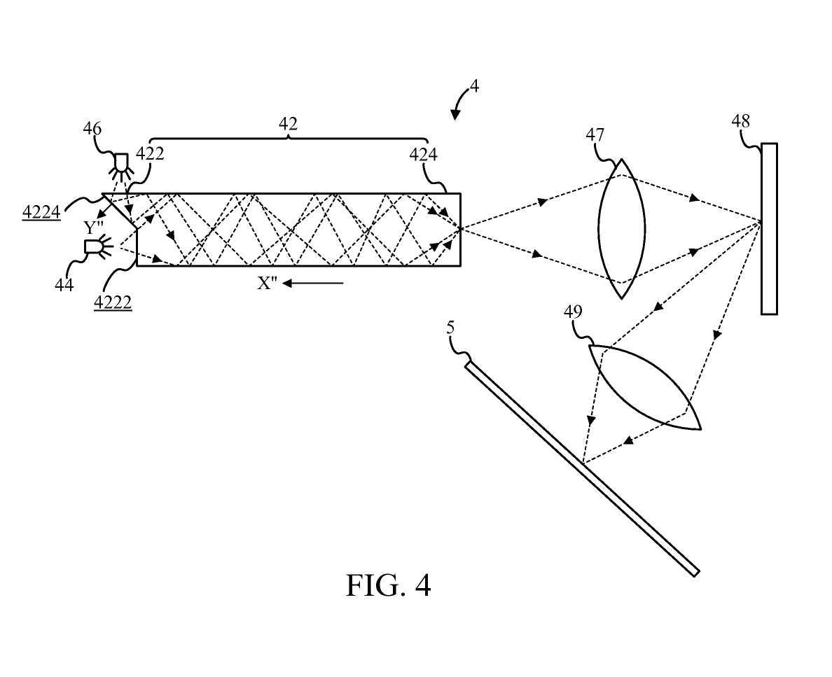

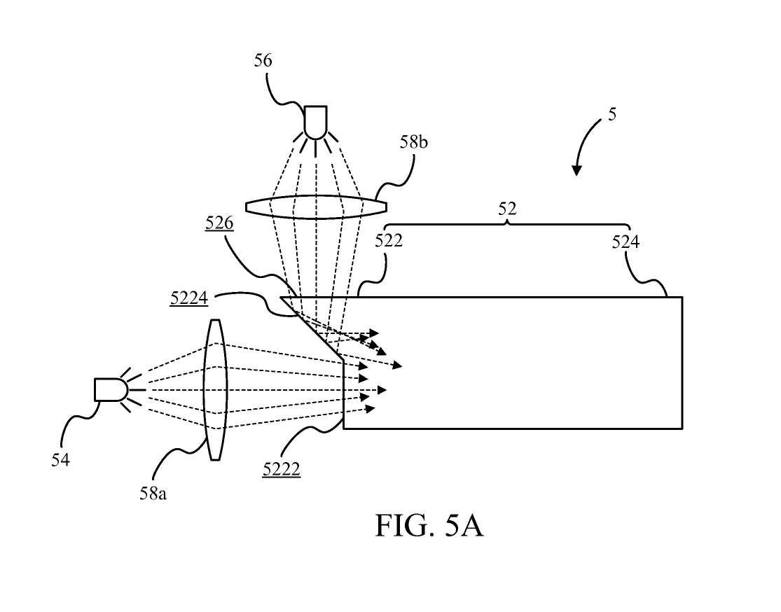

Please refer to FIG. 4. FIG. 4 is a sketch diagram illustrating a fourth preferred embodiment. A light projection system 4 of the invention is to integrate the light integrating system of the invention into the light projection system 4. The light projection system 4 includes an integrating rod 42, a first light source 44, a second light source 46, a digital micromirror device 48, and a projection lens 49. The integrating rod 42 thereon defines an axial direction X″. The integrating rod 42 includes a first end surface 422 and a second end surface 424. The first end surface 422 includes a transmitting surface 4222 and a first reflecting surface 4224. The first reflecting surface 4224 is disposed beside a first side of the transmitting surface 4222. As shown in FIG. 4, the first reflecting surface 4224 is adjacent to the transmitting surface 4222, but it is not limited to this, which can be referred to FIG. 1B.

The transmitting surface 4222 is substantially perpendicular to the axial direction X″. The first reflecting surface 4224 can be coated with a layer of reflection material to enhance reflection, even to produce a full reflection. There is an angle between the normal direction Y″ of the first reflecting surface 4224 and the axial direction X″. In other words, the first reflecting surface 4224 is not parallel to the axial direction X″. FIG. 4 shows that the angle is about 45 degrees, but it is not limited to this.

Furthermore, a first light emitted by the first light source 44 passes through the transmitting surface 4222 into the integrating rod 42. The transmitting surface 4222 can be coated with a layer of anti-reflection material such that the first light can largely pass through the layer of anti-reflection material into the integrating rod 42. The layer of anti-reflection material is usually a metal oxide, but it is not limited to this. A second light emitted by the second light source 46 passes through a side surface of the integrating rod 42 and is reflected by the first reflecting surface 4224 into the integrating rod 42. The integrating rod 42 mixes the first light and the second light reflected by the first reflecting surface 4224 in the integrating rod 42 and then transmits them through the second end surface 424 to the digital micromirror device 48. Then, the digital micromirror device 48 selectively reflects the mixed light of the first light and the second light through the projection lens 49 to a screen 5. Furthermore, a relay lens 47 can be disposed between the integrating rod 42 and the digital micromirror device 48 for concentrating the light transmitted from the integrating rod 42 on the digital micromirror device 48. The travel paths of the first light and the second light are shown in FIG. 4 (shown in dashed lines).

In addition, the light projection system 4 further includes a third light source (not shown in the figure) to increase light sources to enhance the brightness. The first end surface 422 of the integrating rod 42 includes a second reflecting surface (not shown in the figure) correspondingly. A third light emitted by the third light source passes through another side surface of the integrating rod 42 and is reflected by the second reflecting surface into the integrating rod 42. The integrating rod 42 mixes the first light, the second light reflected by the first reflecting surface 4224, and the third light reflected by the second reflecting surface and then transmits them through the second end surface 424 of the integrating rod 42 to the digital micromirror device 48.

Moreover, the light projection system 4 further includes a light guide (not shown in the figure). The light guide is installed in such a way that the second light emitted by the second light source 46 passes through the light guide and the side surface and is then reflected by the first reflecting surface 4224 into the integration rod 42.

Please refer to the above-mentioned preferred embodiments. Regarding the geometric configuration of the third light source and the integrating rod 42, the geometric relation between the first reflecting surface 4224 and the transmitting surface 4222, and additional descriptions for the components in the fourth preferred embodiment, they will not be further described here. Moreover, the operating principle of the digital micromirror device 48 is known well in the projection field, and it will not be described again here. The digital micromirror device 48 here is used as an image modulation device. Therefore, the digital micromirror device 48 can also be replaced by other image modulation device with similar functions, such as an LCD panel device, which will not be further described here. Moreover, the additional description for the components of the light integrating system 4 is the same as that for the corresponding components of the light integrating system 1 in the first embodiment, so it will not be further described here.

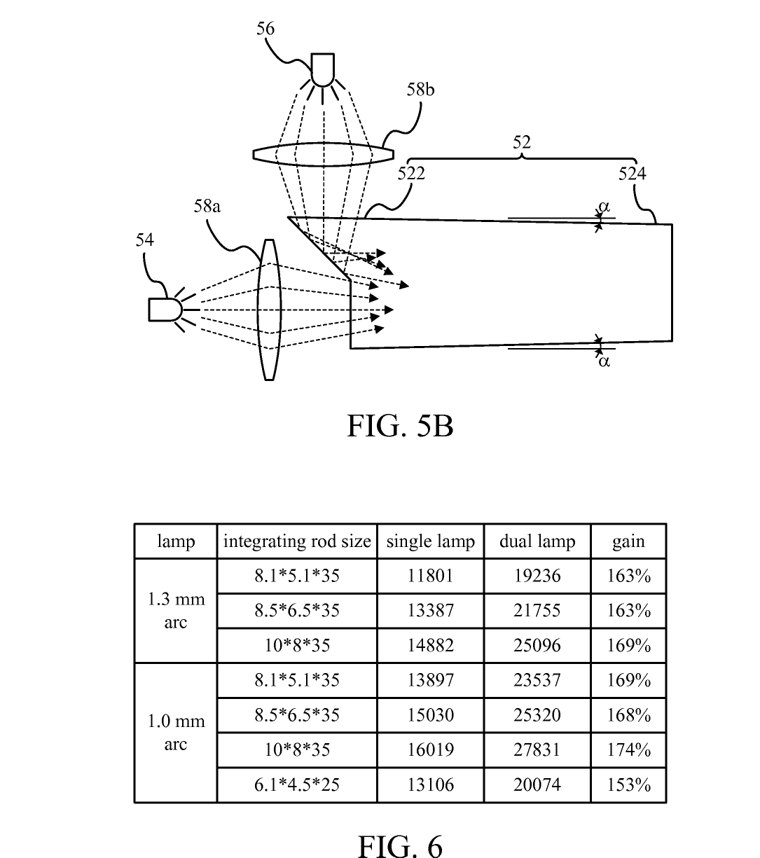

Please refer to FIG. 5A. FIG. 5A is a sketch diagram illustrating a fifth preferred embodiment. Compared with the first embodiment, a light integrating system 5 of the fifth preferred embodiment further includes angular modulation devices 58a and 58b between a first light source 54 and a transmitting surface 5222 and between a second light source 56 and a first side surface 526 of an integrating rod 52. The angular modulation devices 58a and 58b can modulate the incident angle of lights (shown in dashed lines) emitted by the first light source 54 and the second light source 56, as shown in FIG. 5. In the fifth preferred embodiment, the angular modulation device can be a condensing lens or a set of lenses, but the invention is not limited to this.

Furthermore, by adjusting the parameters of the angular modulation devices 58a and 58b, the light out of the second end surface 524 can also be modulated accordingly. In other words, the angle of departure of the light out of the second end surface 524 can be modulated. The more light into the relay lens 47 (refer to FIG. 4), and the brightness is also improved.

In an embodiment, the light source 54 or 56 is LED. In general, the intensity of LED is high even at an angle, such as 60 degrees relative to the center thereof. The angular modulation device 58a or 58b can modulate light emitted at said angle into a smaller incident angle.

In another embodiment, comparing with the fifth preferred embodiment, the cross section of the first end surface 522 of the integrating rod 52 is larger than that of the second end surface 524 of the integrating rod 52, as shown in FIG. 5B. The integrating rod 52 shows a taper substantially, and there is an exaggerated taper angle α shown in FIG. 5B for illustration. Therefore, the integrating rod 52 can integrate more light from the light sources 54 and 56. However, in this case of the integrating rod 52, the angle of departure of the light out of the second end surface 524 is larger than the incident angle thereof, so that the usable light out of the second end surface 524 is reduced. To improve the use of the light out of the second end surface 524, the angular modulation devices 58a and 58b modulate the light emitted from the light sources 54 and 56 by request, so that more light can be concentrated within the utility angle.

Consequently, the angular modulation device 58a can collect more light from the first light source 54 into the integrating rod 52, i.e. the intensity of the light out the second end surface 524 of the integrating rod 52 increases. The above description also applies to the angular modulation device 58b. Furthermore, the light from the second light source 56, which is modulated by the angular modulation device 58b and into the integrating rod 52, can perform total internal reflection better. It is added that the description in the fifth preferred embodiment and in associated embodiments also applies to the fourth preferred embodiment. It will not be further described here.

Please refer to FIG. 6. FIG. 6 is a table of the brightness comparison of the invention to a conventional light integrating system with single light source. In the table, a 1.3 mm-arc lamp and a 1.0 mm-arc lamp are used as light sources respectively. The integrating rod size is measured in mm. For example, 8.1*5.1*35 represents an integrating rod with an 8.1 mm*5.1 mm cross section and a length of 35 mm. The single lamp represents the conventional light integrating system with single light source. The dual lamp represents the light integrating system of the invention. The values in the columns corresponding to the single lamp and the dual lamp represent the brightness of the output of the corresponding integrating systems. The gain is calculated by dividing the value of the single lamp by the value of the dual lamp over. As shown in FIG. 6, the light integrating system with dual lamps has a larger brightness than the convention integrating system with single lamp by 50% or more.

As described above, the light integrating system of the invention can directly utilize an integrating rod to mix two or more different light sources to improve the brightness. By using a light guide, the light integrating system of the invention can break the limitation of the conventional light configuration to mix more light sources. When LEDs are further used as light sources, and the light integrating system of the invention is integrated into a light projection system, the light projection system can skip using a color wheel.

With the recitations of the preferred embodiments above, the features and spirits of the invention will be hopefully well described. However, the scope of the invention is not restricted by the preferred embodiments disclosed above. The objective is that all alternative and equivalent arrangements are hopefully covered in the scope of the appended claims of the invention. Accordingly, the above disclosure should be construed as limited only by the metes and bounds of the appended claims.

What is claimed is:

1. A light integrating system, comprising:
an integrating rod thereon defining an axial direction, the integrating rod comprising a first end surface and a second end surface, the first end surface comprising a transmitting surface and a first reflecting surface disposed beside a first side of the transmitting surface, there being a first angle between a normal direction of the first reflecting surface and the axial direction, the transmitting surface being substantially perpendicular to the axial direction;
a first light source emitting a first light through the transmitting surface into the integrating rod; and
a second light source emitting a second light through a first side surface of the integrating rod and reflected by the first reflecting surface into the integrating rod;
wherein the integrating rod mixes the first light and the second light reflected by the first reflecting surface in the integrating rod and then transmits them through the second end surface.

2. The light integrating system of claim 1, further comprising a third light source, wherein the first end surface of the integrating rod comprises a second reflecting surface disposed beside a second side of the transmitting surface, there is a second angle between a normal direction of the second reflecting surface and the axial direction, the third light source emits a third light through a second side surface of the integrating rod and reflected by the second reflecting surface into the integrating rod, and the integrating rod mixes the first light, the second light reflected by the first reflecting surface, and the third light reflected by the second reflecting surface in the integrating rod and then transmits them through the second end surface.

3. The light integrating system of claim 2, wherein the first side is opposite to the second side, and the first reflecting surface and the second reflecting surface are respectively adjacent to the transmitting surface.

4. The light integrating system of claim 2, wherein the first reflecting surface is adjacent to the second reflecting surface.

5. The light integrating system of claim 1, wherein the first reflecting surface is adjacent to the transmitting surface, there is a third angle between the first reflecting surface and the transmitting surface, and the third angle is from 90 degrees to 180 degrees or from 180 degrees to 270 degrees.

6. The light integrating system of claim 1, wherein two sides of the first reflecting surface are adjacent to the transmitting surface and the first side surface respectively.

7. The light integrating system of claim 1, wherein the integrating rod comprises a third side surface opposite to the first side surface, two sides of the first reflecting surface are adjacent to the transmitting surface and the third side surface respectively.

8. The light integrating system of claim 1, further comprising a light guide, the light guide being installed such that the second light emitted by the second light source passes through the light guide and the first side surface and is then reflected by the first reflecting surface into the integration rod.

9. The light integrating system of claim 1, further comprising an angular modulation device disposed between the first light source and the transmitting surface and/or between the second light source and the first side surface for modulating the emitting angle of the first light and/or the second light.

10. The light integrating system of claim 1, wherein a cross section of the first end surface is larger than a cross section of the second end surface.

11. A light projection system, comprising:
an integrating rod thereon defining an axial direction, the integrating rod comprising a first end surface and a second end surface, the first end surface comprising a transmitting surface and a first reflecting surface disposed beside a first side of the transmitting surface, there being a first angle between a normal direction of the first reflecting surface and the axial direction, the transmitting surface being substantially perpendicular to the axial direction;
a first light source emitting a first light through the transmitting surface into the integrating rod;
a second light source emitting a second light through a first side surface of the integrating rod and reflected by the first reflecting surface into the integrating rod;
an image modulation device; and
a projection lens;
wherein the integrating rod mixes the first light and the second light reflected by the first reflecting surface in the integrating rod and then transmits them through the second end surface to the image modulation device, and the modulation device then selectively controls the first light and the second light mixed to be projected via the projection lens.

12. The light projection system of claim 11, further comprising a third light source, wherein the first end surface of the integrating rod comprises a second reflecting surface disposed beside a second side of the transmitting surface, there is a second angle between a normal direction of the second reflecting surface and the axial direction, the third light source emits a third light through a second side surface of the integrating rod and reflected by the second reflecting surface into the integrating rod, and the integrating rod mixes the first light, the second light reflected by the first reflecting surface, and the third light reflected by the second reflecting surface in the integrating rod and then transmits them through the second end surface to the image modulation device.

13. The light projection system of claim 12, wherein the first side is opposite to the second side, and the first reflecting surface and the second reflecting surface are respectively adjacent to the transmitting surface.

14. The light projection system of claim 12, wherein the first reflecting surface is adjacent to the second reflecting surface.

15. The light projection system of claim 11, wherein the first reflecting surface is adjacent to the transmitting surface, there is a third angle between the first reflecting surface and the transmitting surface, and the third angle is either from 90 degrees to 180 degrees or from 180 degrees to 270 degrees.

16. The light projection system of claim 11, wherein two sides of the first reflecting surface are adjacent to the transmitting surface and the first side surface respectively.

17. The light projection system of claim 11, wherein the integrating rod comprises a third side surface opposite to the first side surface, two sides of the first reflecting surface are adjacent to the transmitting surface and the third side surface respectively.

18. The light projection system of claim 11, further comprising a light guide, the light guide being installed such that the second light emitted by the second light source passes through the light guide and the first side surface and is then reflected by the first reflecting surface into the integration rod.

19. The light projection system of claim 11, further comprising an angular modulation device disposed between the first light source and the transmitting surface and/or between the second light source and the first side surface for modulating the emitting angle of the first light and/or the second light.

20. The light projection system of claim 11, wherein a cross section of the first end surface is larger than a cross section of the second end surface.
